(19) United States
(12) Patent Application Publication
(10) Pub. No.: US 2017/0209897 A1
(43) Pub. Date: Jul. 27, 2017

(54) HEAT COMPOSITE SYSTEM BASED ON POLYURETHANE RIGID FOAM FOR BUILDING FACADES

(71) Applicant: BASF SE, Ludwigshafen am Rhein (DE)

(72) Inventors: Oliver Clamor, Stemwede-Dielingen (DE); Gunnar Kampf, Stemwede-Haldem (DE); Andrea Eisenhardt, Vechta (DE); Erhard Gleinig, Senftenberg (DE); Sven Moennig, Remseck (DE); Sarunas Turcinskas, Trostberg (DE); Dirk Weinrich, Osnabrueck (DE)

(73) Assignee: BASF SE, Ludwigshafen am Rhein (DE)

(21) Appl. No.: 15/500,399

(22) PCT Filed: Jul. 14, 2015
(86) PCT No.: PCT/EP2015/066034

§ 371 Date: Jan. 30, 2017

(30) Foreign Application Priority Data
Jul. 31, 2014 (EP) 14179252.3

(51) Int. Cl. B05D 1/02; E04B 1/76; B05D 1/28

(52) U.S. Cl. CPC B05D 1/02; B05D 1/28; E04B 1/762; E04B 2001/7691

(57) ABSTRACT

The present invention relates to a process for the production of a composite element. The process includes (i) provision of an outer layer with an uncoated surface and a coated surface coated at least partially with a composition (B) including at least one inorganic material, (ii) treatment of the uncoated surface of the outer layer and (iii) application, to the treated surface of the outer layer, of a composition (Z2) suitable for the production of a polyurethane foam and/or polyisocyanurate foam. The present invention further relates to a composite element obtainable or obtained by a process of the invention, and also to the use of a composite element obtainable or obtained by a process of the invention or of a composite element of the invention as insulation material or in the construction of façades.

The present invention relates to a process for the production of a composite element, at least comprising the provision of an outer layer with an uncoated surface and a coated surface coated at least partially with a composition (B) comprising at least one inorganic material, treatment of the uncoated surface of the outer layer and application, to the treated surface of the outer layer, of a composition (Z2) suitable for the production of a polyurethane foam and/or polyisocyanurate foam. The present invention further relates to a composite element obtainable or obtained by a process of the invention, and also to the use of a composite element obtainable or obtained by a process of the invention or of a composite element of the invention as insulation material or in the construction of façades.

Composite thermal insulation systems (CTIS) are usually composed of an insulation-material layer made of, for example, polystyrene or mineral wool, secured to an external wall of a building by means of suitable mineral adhesives and/or pins. In order to preserve the composite thermal insulation system within the entire structure, an external layer composed of mineral adhesives, renders, and also optionally of reinforcing elements such as glassfiber mats is then applied to said insulation-material layer, and provides protection for same. The function of the composite thermal insulation system consists in the thermal insulation of new or existing buildings. The composite thermal insulation system moreover protects the external wall of buildings from exterior effects such as moisture.

Familiar composite thermal insulation systems are typically based on insulation-material layers made of expanded polystyrene (EPS). These exhibit good adhesion to mineral adhesives, but their thermal conductivity is usually at least 30 mW/m*K.

Insulation-material layers made of rigid polyurethane foam (rigid PU foam) can alternatively be used. These have lower thermal conductivity of, for example, less than 20-25 mW/m*K with a resultant improvement in thermal insulation in comparison with expanded polystyrene. Said layers are coated with outer layers impermeable to diffusion, e.g. metal foils or suitable polymer foils, but these exhibit inadequate adhesion to mineral adhesives commercially available for composite thermal insulation systems.

EP 1431473 and EP 2210991 describe CTIS with insulation layers and with outer layers impermeable to diffusion, with polystyrene layers applied to external surfaces of these in order to improve adhesion to mineral adhesives.

WO 2013/143798 describes CTIS comprising PU insulation layers or polyisocyanurate insulation layers (PIR insulation layers) with metal outer layers impermeable to diffusion, with layers made of PU or PIR applied to an external side of these in order to improve adhesion to mineral adhesives. These layers can be produced from two liquid components, and can be applied continuously after or during production of the insulation element.

A feature common to all of these processes is that production of the insulation-material elements which are needed for the CTIS insulation layer, and which are composed of insulation layer and of outer layers impermeable to diffusion, requires adhesive bonding of, or application of, further layers to the external sides of the elements in order to achieve adequate adhesion to mineral adhesives. Said adhesive bonding or application requires additional production steps or increased complexity of production processes in comparison with the processes usually used at present for production of insulation elements.

It is therefore an object of the invention to provide an insulation-material element for a composite thermal insulation system with improved thermal conductivity, where said element preferably has outer layers that are impermeable to diffusion and achieves adequate adhesion between PU insulation layer, outer layers, and mineral adhesive in the composite thermal insulation system. Another object of the invention was to provide a process for the production of composite elements which have improved adhesion between the core and the outer layer, i.e. by way of example a rigid polyurethane foam core or a rigid polyisocyanurate foam core and the outer layer.

Said object is achieved in the invention via a process for the production of a composite element, at least comprising the following steps:
i) provision of an outer layer with an uncoated surface and a coated surface coated at least partially with a composition (B) comprising at least one inorganic material;
ii) treatment of the uncoated surface of the outer layer;
iii) application, to the outer-layer surface treated in step ii), of a composition (Z2) suitable for the production of a polyurethane foam and/or polyisocyanurate foam.

Use of an outer layer with a surface which has been at least partially coated and which exhibits good adhesion to mineral adhesives permits simpler and more cost-effective production of the insulation elements and of the resultant composite thermal insulation system. The process of the invention permits production of composite thermal insulation systems which exhibit good adhesion to mineral adhesives without any requirement to apply an additional layer made of, for example, polystyrene or of polyurethanes to the external sides of the outer layers.

A surface of the outer layer provided in step (i) has been coated in the invention at least partially with a composition (B) comprising at least one inorganic material. The outer layer has been coated in the invention in order, in comparison with an uncoated outer layer, to improve adhesion to mineral adhesives. The degree of coating here can vary in the invention as long as good adhesion to mineral adhesives is ensured. By way of example, it is also possible that individual regions of the outer layer have been coated, and that others have not been coated. By way of example, a composition (B) has coated at least 50% of a coated surface of the outer layer. The composition (B) has preferably coated at least 75% of the outer layer, more preferably at least 80%, particularly preferably at least 90%.

An embodiment of the present invention accordingly provides a process for the production of a composite element as described above where the composition (B) has coated at least 50% of the coated surface of the outer layer.

Another embodiment of the invention accordingly provides a process for the production of a composite element as described above where the composition (B) has coated at least 75% of the coated surface of the outer layer.

The process of the invention comprises at least the steps i), ii), and iii). However, it is also possible in the invention that the process comprises further steps.

Step i) provides an outer layer with an uncoated surface and with a coated surface coated at least partially with a composition (B) comprising at least one inorganic material. This can be achieved in continuous production plants by way of example through unwinding of a rolled-up outer layer from a roll. The nature of the outer layer can vary widely, but it is preferable here to use the materials usually used for outer layers in the thermal insulation sector. The thickness of the at least partially coated outer layer can by way of example be in the range from 0.01 mm to 5 mm, preferably from 0.05 mm to 2 mm, particularly preferably from 0.1 mm to 1 mm, more specifically from 0.2 mm to 0.8 mm, and more preferably in the range from 0.3 mm to 0.7 mm.

Another embodiment of the present invention accordingly provides a process for the production of a composite element as described above where the thickness of the at least partially coated outer layer is in the range from 0.01 mm to 5.0 mm.

The composition (B) comprises at least one inorganic material. The composition (B) preferably further comprises at least one binder. The quantity of the inorganic material comprised in the composition (B) here can vary widely. The quantity of the inorganic material comprised by the composition (B) is preferably in the range from 50 to 99% by weight, in particular in the range from 60 to 98% by weight, more preferably in the range from 70 to 95% by weight, based in each case on the entire composition (B). The composition (B) preferably comprises further constituents, for example a quantity of at least one binder in the range from 1 to 50% by weight, in particular in the range from 2 to 40% by weight, more preferably in the range from 5 to 30% by weight, based in each case on the entire composition (B).

The inorganic material here can vary widely. Examples of materials suitable in the invention are pulverulent inorganic materials, fibrous inorganic materials, and also inorganic textiles. A pulverulent inorganic material is in particular used in order to achieve uniform distribution.

The quantity of the inorganic material comprised in the composition (B) here is by way of example in the range from 50 to 99%, in particular in the range from 60 to 98% by weight, more preferably in the range from 70 to 95% by weight, based in each case on the entire composition (B).

The quantity of the pulverulent inorganic material comprised in the composition (B) is by way of example from 50 to 99% by weight, in particular in the range from 60 to 98% by weight, more preferably in the range from 70 to 95% by weight, based in each case on the entire composition (B).

Another embodiment of the present invention accordingly provides a process for the production of a composite element as described above where the composition (B) comprises from 70 to 95% by weight of a pulverulent inorganic material and from 5 to 30% by weight of a binder, based in each case on the entire composition (B).

Binders that can be used are not only those based on inorganic material, for example waterglass, but also those based on organic material, in particular based on plastics.

The binders based on plastics are preferably used in the form of plastics dispersions with from 35 to 70% by weight solids content. Materials that can be used are in particular polyvinyl chloride and polyvinylidene chloride, and co- and terpolymers of vinyl acetate with maleic acid and acrylic acid. Particular preference is given to styrene-butadiene copolymers and to polymers/copolymers of acrylic acid and, respectively, methacrylic acid.

Materials suitable as inorganic material are in particular pulverulent substances, in particular those based on minerals, examples being silicates, calcium carbonate, aluminum oxide, aluminum hydroxide, and aluminum oxide hydrate. Inorganic textiles or fibers are by way of example also suitable in the invention, examples being glassfibers.

It is also possible in the invention to use mixtures of various inorganic materials, for example a mixture of from 10 to 50% by weight of calcium carbonate and from 90 to 50% by weight of aluminum hydroxide or aluminum oxide hydrate.

The composition (B) can comprise further constituents in the invention, in particular further inorganic or organic dyes, titanium oxide, or carbon black.

Conventional outer layers can in particular be used as outer layer. It is preferable for the purposes of the present invention that the outer layer is impermeable to diffusion.

For the purposes of the present invention, the impermeability of the outer layer to diffusion relates in particular to blowing agents remaining in the cell matrix for prolonged periods, examples being hydrocarbons such as pentane or cyclopentane, fluorocarbons, and carbon dioxide. For the purposes of the present invention, even if a foil is impermeable to diffusion in the sense of the present invention, there can be a small extent of diffusion of other constituents of air, for example water, oxygen, and nitrogen.

Another embodiment of the present invention accordingly provides a process for the production of a composite element as described above where the outer layer is impermeable to diffusion.

It is also possible in the invention that the outer layer is composed of a plurality of sublayers of which at least one is preferably impermeable to diffusion.

Another embodiment of the present invention provides a process for the production of a composite element as described above where the outer layer has a plurality of sublayers. The outer layer can by way of example have two or three sublayers.

By way of example, metal foils or plastics foils are suitable as outer layer in the invention.

An embodiment of the present invention accordingly provides a process for the production of a composite element as described above where the outer layer comprises a plastics foil or a metal foil. Another embodiment of the present invention also provides a process for the production of a composite element as described above where the outer layer comprises a plastics film that is impermeable to diffusion or a metal foil.

Another embodiment of the present invention accordingly provides a process for the production of a composite element as described above where the outer layer comprises a metal foil.

The coating here can for the purposes of the present invention be applied to the outer layer by known processes, for example by spraying or spreading. For the purposes of the present invention it is possible here that the coating is applied and then the outer layer thus coated is stored and is used subsequently in the process of the invention. However, it is also equally possible that the coating is applied shortly prior to use of the outer layer in the process of the invention.

The process of the invention further comprises step ii). Step ii) treats the uncoated surface of the outer layer. The treatment serves to improve adhesion, on the outer layer, of a layer that is to be applied. Suitable methods for the purposes of the present invention are in particular plasma treatment, corona treatment, flame treatment, or use of an adhesion promoter.

Another embodiment of the present invention accordingly provides a process for the production of a composite element as described above where the treatment in step ii) is selected from corona treatment, plasma treatment, flame treatment, and application of a composition (Z1) comprising at least one adhesion promoter. It is likewise possible to use other processes which improve adhesion, on the outer layer, of a layer that is to be applied. It is also possible to combine the various measures for the purposes of the present invention. By way of example, for the purposes of the present invention the treatment in step ii) can comprise corona treatment and application of a composition (Z1) comprising at least one adhesion promoter, or else plasma treatment and application of a composition (Z1) comprising at least one adhesion promoter.

Suitable processes and apparatuses for corona treatment of an outer layer, in particular of a foil are already known. It is in principle possible to use any of the known processes for the purposes of the present invention. For the purposes of the present invention it is preferable that the corona treatment takes place continuously.

Suitable processes and apparatuses for plasma treatment of an outer layer, in particular of a foil, are likewise known. It is in principle possible to use any of the known processes for the purposes of the present invention. For the purposes of the present invention it is preferable that the plasma treatment takes place continuously.

For the purposes of the present invention it is preferable to use a composition (Z1) which comprises at least one adhesion promoter and which is more preferably applied continuously to the outer layer. Another embodiment of the present invention accordingly provides a process for the production of a composite element as described above where the treatment in step ii) comprises application of a composition (Z1) comprising at least one adhesion promoter.

By way of example, single- or two-component adhesion promoters are suitable as adhesion promoter for the purposes of the present invention. It is possible here for the purposes of the present invention to use any of the suitable adhesion promoters known to the person skilled in the art. By way of example, a 2-component adhesion promoter is used which comprises, as constituents, a polyisocyanate and a compound reactive toward isocyanates. Another suitable material is a single-component adhesion promoter comprising a polyisocyanate prepolymer or a single-component adhesion promoter comprising a compound reactive toward isocyanates.

In step ii) it is therefore possible by way of example to apply, to the outer layer, a composition (Z1) comprising at least one compound reactive toward isocyanates. The composition can equally comprise at least one polyisocyanate prepolymer, or a polyisocyanate and a compound reactive toward isocyanates.

Step ii) therefore applies, to the outer layer, by way of example, a composition (Z1) comprising at least one compound reactive toward isocyanates. Conventional techniques, for example spray-application or rolling, can be used for the application process here.

Another embodiment of the present invention provides a process for the production of a composite element as described above where the composition (Z1) is applied to the outer layer by means of spray-application or rolling.

For the purposes of the present invention, the composition (Z1) preferably comprises at least one compound reactive toward isocyanates. The composition (Z1) in the invention can also comprise two or more compounds reactive toward isocyanates. For the purposes of the present invention, suitable compounds reactive toward isocyanates are in principle any of the compounds having functional groups that are reactive toward isocyanates. Suitable compounds are in particular compounds having OH functional groups, compounds having NH functional groups, and compounds having SH functional groups. The expression “compounds having NH functional groups” here comprises not only primary amines but also secondary amines.

Another embodiment of the present invention accordingly provides a process for the production of a composite element as described above where the adhesion promoter is a compound reactive toward isocyanates or is a polyisocyanate prepolymer.

An alternative embodiment of the present invention provides a process for the production of a composite element as described above where the composition (Z1) comprises at least one compound reactive toward isocyanates and at least one polyisocyanate.

Another embodiment of the present invention accordingly provides a process for the production of a composite element as described above where the at least one compound reactive toward isocyanates is selected from the group consisting of compounds having OH functional groups, compounds having NH functional groups, and compounds having SH functional groups. It is also possible here in the invention to use mixtures of two or more of the compounds mentioned. It is further preferable to use compounds selected from the group consisting of compounds having OH functional groups and compounds having NH functional groups, where these compounds are reactive toward isocyanates. Particular preference is given in the invention to compounds selected from the group consisting of compounds having OH functional groups, where these compounds are reactive toward isocyanates.

Another embodiment of the present invention accordingly provides a process for the production of a composite element as described above where the at least one compound reactive toward isocyanates is selected from the group consisting of polyethers, polyesters, compounds bearing ester and ether groups, compounds bearing urethane and ester and/or ether groups and compounds bearing urethane groups.

Preference is given in the invention to compounds which are reactive toward isocyanates and react with isocyanates without liberation of gases. For the purposes of the present invention, preference is further given to compounds which are reactive toward isocyanates and do not undergo any internal reaction or any reaction with air or with atmospheric moisture.

It is preferable that compounds reactive toward isocyanates are polyethers and/or polyesters, and/or compounds which have not only ester groups but also ether groups, and/or compounds which comprise urethane, ester, and/or ether functions, preferably polyethers and/or polyesters, and/or compounds which comprise not only ester groups but also ether groups, particularly preferably polyethers and/or polyesters, specifically polyethers.

Polyether polyols are particularly preferred in the invention as compounds reactive toward isocyanates. The polyether polyols can be produced by known processes, for example by anionic polymerization of one or more alkylene oxides having from 2 to 4 carbon atoms with alkali metal hydroxides, for example sodium hydroxide or potassium hydroxide, alkali metal alcoholates, for example sodium methanolate, sodium ethanolate, potassium ethanolate, or potassium isopropanolate, or with aminic alkoxylation catalysts such as dimethylethanolamine (DMEOA), imidazole, or imidazole derivatives with use of at least one starter molecule or starter molecule mixture which comprises an average of from 2 to 8, preferably from 2 to 6, reactive hydrogen atoms, or by cationic polymerization with Lewis acids, for example antimony pentachloride, boron fluoride etherate, or bleaching earth. Examples of suitable alkylene oxides are tetrahydrofuran, propylene 1,3-oxide, butylenes 1,2- or 2,3-oxide, styrene oxide, and preferably ethylene oxide and propylene 1,2-oxide. The alkylene oxides can be used individually, in alternating succession, or in the form of mixtures. Preferred alkylene oxides are propylene oxide and ethylene oxide, particularly propylene oxide.

Examples of starter molecules that can be used are the following compounds: organic dicarboxylic acids, for example succinic acid, adipic acid, phthalic acid, and terephthalic acid, aliphatic and aromatic, optionally N-mono-, N,N-, or N,N′-dialkyl-substituted diamines having from 1 to 4 carbon atoms in the alkyl moiety, for example optionally mono- or dialkyl-substituted ethylenediamine, diethylenetriamine, triethylenetetramine, 1,3-propylenediamine, 1,3- and 1,4-butylenediamine, 1,2-, 1,3-, 1,4-, 1,5-, and 1,6-hexamethylenediamine, phenylenediamines, 2,3-, 2,4-, and 2,6-tolylenediamine, and 4,4′-, 2,4′-, and 2,2′-diamino-diphenylmethane. Particular preference is given to the diprimary amines mentioned, for example ethylenediamine. Other starter molecules that can be used are: alkanolamines, e.g. ethanolamine, N-methyl- and N-ethylethanolamine, dialkanolamines, e.g. diethanolamine, N-methyl- and N-ethyldiethanolamine, and trialkanolamines, e.g. triethanolamine, and ammonia. It is preferable to use dihydric or polyhydric alcohols (also known as “starters”), for example ethanediol, 1,2- and 1,3-propanediol, diethylene glycol (DEG), dipropylene glycol, 1,4-butanediol, 1,6-hexanediol, glycerol, trimethylolpropane, pentaerythritol, sorbitol, and sucrose. It is particularly preferable to use a starter or starter mixture with OH functionality less than or equal to 6, preferably less than or equal to 5, particularly preferably less than or equal to 4, more specifically less than or equal to 3, and very specifically less than or equal to 2. It is also possible to add fatty acids or fatty acid derivatives, for example fatty acid esters, to the starter mixture so that during the alkoxylation a certain proportion of the OH functions is esterified by the fatty acid.

It is further possible to use polyesterols as compound reactive toward isocyanates in the composition (Z1). Suitable polyester polyols can be produced from organic dicarboxylic acids having from 2 to 12 carbon atoms, preferably aromatic dicarboxylic acids, or mixtures of aromatic and aliphatic dicarboxylic acids, and polyhydric alcohols, preferably diols and/or polyols, or alkoxylates of these, particularly preferably diols and/or triols, or alkoxylates of these.

Dicarboxylic acids that can in particular be used are: succinic acid, glutaric acid, adipic acid, suberic acid, azelaic acid, sebacic acid, decanedicarboxylic acid, maleic acid, fumaric acid, phthalic acid, isophthalic acid, and terephthalic acid. The dicarboxylic acids here can be used either individually or else in a mixture. It is also possible to use the corresponding dicarboxylic acid derivatives instead of the free dicarboxylic acids, examples being dicarboxylic esters of alcohols having from 1 to 4 carbon atoms and dicarboxylic anhydrides. Aromatic dicarboxylic acids preferably used are phthalic acid, phthalic anhydride, terephthalic acid, and/or isophthalic acid, in a mixture or alone. Aliphatic dicarboxylic acids preferably used are dicarboxylic acid mixtures of succinic, glutaric, and adipic acid in quantitative proportions of, for example, from 20 to 35: from 35 to 50: from 20 to 32 parts by weight, and in particular adipic acid. Examples of dihydric and polyhydric alcohols, in particular diols and/or triols, are: ethanediol, diethylene glycol, 1,2- and 1,3-propanediol, dipropylene glycol, 1,4-butanediol, 1,5-pentanediol, 1,6-hexanediol, 1,10-decanediol, glycerol, trimethylolpropane, and pentaerythritol, and alkoxylates of these. It is preferable to use ethanediol, diethylene glycol, glycerol and alkoxylates of these, or a mixture of at least two of the polyols mentioned. It is further possible to use polyester polyols derived from lactones, e.g. epsilon-caprolactone, or hydroxycarboxylic acids, e.g. ω-hydroxycaproic acid.

It is also possible to produce the polyester polyols by using biologically derived starting materials and/or derivatives of these, for example castor oil, polyhydroxy fatty acids, ricinoleic acid, hydroxy-modified oils, grapeseed oil, black cumin oil, pumpkin seed oil, borage seed oil, soybean oil, wheatgerm oil, rapeseed oil, sunflower oil, peanut oil, apricot kernel oil, pistachio nut oil, almond oil, olive oil, macadamia nut oil, avocado oil, sea buckthorn oil, sesame oil, hemp oil, hazelnut oil, evening primrose oil, wild rose oil, safflower oil, walnut oil, fatty acids, hydroxy-modified fatty acids, and fatty acid esters based on myristoleic acid, palmitoleic acid, oleic acid, vaccenic acid, petroselinic acid, gadoleic acid, erucic acid, nervonic acid, linoleic acid, α- and γ-linolenic acid, stearidonic acid, arachidonic acid, timnodonic acid, clupanodonic acid, and cervonic acid.

Insofar as polyesterols are used as compound reactive toward isocyanates in the composition (Z1), these preferably comprise less than 20% by weight, particularly less than 15% by weight, more specifically less than 10% by weight, very specifically less than 5% by weight, and most specifically 0% by weight, based on the weight of the polyesterol, of fatty acids. It is further possible to use compounds in which polyesters are alkoxylated as starters in the process described above.

The composition (Z1) in the invention can comprise one or more compounds reactive toward isocyanates, in particular one or more compounds selected from the group of polyetherols and polyesterols. In this case it is preferable that polyesterol content is smaller than 90% by weight, with preference smaller than 50% by weight, particularly preferably smaller than 25% by weight, more specifically smaller than 10% by weight, based on the quantity of the compound reactive toward isocyanates in the composition (Z1). It is more preferable that, in the composition (Z1), the compound reactive toward isocyanates is composed exclusively of alkoxylates of a starter or a starter mixture. It is preferable that no polyesterols are used as compound reactive toward isocyanates in the composition (Z1).

Insofar as a composition (Z1) is used, the molar mass of the compound(s) reactive toward isocyanates in the composition (Z1) is preferably greater than 50 g/mol, preferably greater than 150 g/mol, particularly preferably greater than 200 g/mol, more specifically greater than 400 g/mol, still more specifically greater than 500 g/mol, more preferably greater than 700 g/mol, and very specifically greater than 900 g/mol.

It is preferable that the OH number of the compound reactive toward isocyanates is smaller than 1500 mg KOH/g, preferably smaller than 1000 mg KOH/g, particularly preferably smaller than 800 mg KOH/g, more specifically smaller than 500 mg KOH/g, still more specifically smaller than 300 mg KOH/g, more preferably smaller than 200 mg KOH/g. Suitable OH numbers of the compound reactive toward isocyanates are preferably in the range from 10 to 200 mg KOH/g.

The OH functionality of the compound reactive toward isocyanates is preferably smaller than or equal to 8, preferably smaller than or equal to 6, particularly preferably smaller than or equal to 5, more specifically smaller than or equal to 4, still more specifically smaller than or equal to 3. The OH functionality of the compound reactive toward isocyanates is preferably in the range from 1 to 4, more preferably in the range from 2 to 3.

However, the OH functionality of the compound which is present in the composition (Z1) and is reactive toward isocyanates is preferably greater than or equal to 1, with preference greater than or equal to 1.5.

It is preferable that the ratio by mass of ethylene oxide to propylene oxide used for production of the compound reactive toward isocyanates comprised in the composition (Z1) is less than or equal to 9, preferably less than or equal to 3, particularly preferably less than or equal to 1, more specifically less than or equal to 0.5, still more specifically less than or equal to 0.2, and very specifically less than or equal to 0.1. It is particularly preferable to use exclusively propylene oxide for production of the compound reactive toward isocyanates comprised in the composition (Z1).

Another embodiment of the present invention applies, in step ii), a composition (Z1) which comprises at least one polyisocyanate and comprises at least one compound reactive toward isocyanates.

Suitable compounds reactive toward isocyanates are those mentioned above.

Polyisocyanates used can be aliphatic, cycloaliphatic, araliphatic, and/or aromatic diisocyanates. The following aromatic isocyanates may be mentioned individually by way of example: tolylene 2,4-diisocyanate, mixtures of tolylene 2,4- and 2,6-diisocyanate, diphenylmethane 4,4′-, 2,4′-, and/or 2,2′-diisocyanate (MDI), mixtures of diphenylmethane 2,4′- and 4,4′-diisocyanate, urethane-modified liquid diphenylmethane 4,4′- and/or 2,4-diisocyanates, 4,4′-diisocyanatodiphenylethane, mixtures of monomeric methanediphenyl diisocyanates and homologs of methanediphenyl diisocyanate having a larger number of rings (polymer MDI), and naphthylene (1,2-) and 1,5-diisocyanate.

Aliphatic diisocyanates used are usually aliphatic and/or cycloaliphatic diisocyanates, for example tri-, tetra-, penta-, hexa-, hepta-, and/or octamethylene diisocyanate, 2-methylpentamethylene 1,5-diisocyanate, 2-ethylbutylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate, and dicyclohexylmethane 4,4′-, 2,4′-, and/or 2,2′-diisocyanate.

By way of example for the purposes of the present invention, a composition (Z1) is used that comprises a compound which is reactive toward isocyanates and is selected from the group consisting of polyether polyols and polyester polyols, and diphenylmethane 4,4′-, 2,4′-, and/or 2,2′-diisocyanate (MDI).

In another embodiment of the present invention the composition (Z1) can also comprise a polyisocyanate prepolymer as adhesion promoter. Polyisocyanate prepolymers are obtainable by reacting polyisocyanates described above in excess with polyols to give the prepolymer, for example at temperatures of from 30 to 100° C., preferably at about 80° C. It is preferable that the prepolymers of the invention are produced by using polyisocyanates and commercially available polyols based on polyesters, for example derived from adipic acid, or polyethers, for example derived from ethylene oxide and/or propylene oxide.

Polyols are known to the person skilled in the art and are described by way of example in “Kunststoffhandbuch, Band 7, Polyurethane” [Plastics handbook, Volume 7, Polyurethanes], Carl Hanser Verlag, 3^{rd} edition 1993, chapter 3.1. It is preferable that polyols used here are polymeric compounds having hydrogen atoms reactive toward isocyanates. Polyols particularly preferably used are polyetherols.

During production of the isocyanate prepolymers, conventional chain extenders or crosslinking agents are optionally added to the polyols mentioned. Chain extender used is particularly preferably 1,4-butanediol, dipropylene glycol, and/or tripropylene glycol. The ratio of organic polyisocyanates to polyols and chain extenders here is preferably selected in such a way that the NCO content of the isocyanate prepolymer is from 2 to 30%, preferably from 6 to 28%, particularly preferably from 10 to 24%.

Particular preference is given to prepolymers of the polyisocyanates selected from the group consisting of MDI, polymer MDI, and TDI, and also to derivatives of these.

The composition (Z1) can, for the purposes of the present invention, comprise further compounds, for example flame retardants, blowing agents, or else catalysts for polyurethane formation or polyisocyanurate formation.

Another embodiment of the present invention provides a process for the production of a composite element as described above where the composition (Z1) comprises one or more of the following components:
(i) flame retardants;
(ii) blowing agents;
(iii) catalysts for polyurethane formation or polyisocyanurate formation.

It is also possible in the invention that the composition (Z1) here comprises any desired combination of the components mentioned, for example only component (i) or (ii) or (iii), or components (i) and (ii), or components (i) and (iii), or component (ii) and component (iii). The quantities used of the compounds mentioned in the composition (Z1) can be the conventional quantities known in principle to the person skilled in the art.

The composition (Z1) can comprise a blowing agent, for example a chemical or physical blowing agent. It is preferable to add, to the compound reactive toward isocyanates, less than 5% by weight, preferably less than 2% by weight, particularly preferably less than 1% by weight, more specifically less than 0.5% by weight, still more specifically less than 0.2% by weight, and very particularly 0% by weight, based on the quantity of the compound reactive toward isocyanates, of chemical blowing agents, i.e. compounds which react with isocyanate to form a gas, preferably water or formic acid, particularly preferably water.

It is preferable to add, to the composition (Z1), less than 20% by weight, preferably less than 10% by weight, particularly preferably less than 5% by weight, more specifically less than 1% by weight, and very particularly 0% by weight, based on the quantity of the isocyanate-reactive compound, of low-boiling-point components unreactive to isocyanate, known as physical blowing agents.

Flame retardants in any form can moreover be added to the composition (Z1). Flame retardants that can be used are generally flame retardants known from the prior art. Examples of suitable flame retardants are brominated esters, brominated ethers (Ixol), and brominated alcohols such as dibromoneopentyl alcohol, tribromoneopentyl alcohol, and PHT-4-diol, and also chlorinated phosphates such as tris(2-chloroethyl) phosphate, tris(2-chloropropyl) phosphate (TCPP), tris(1,3-dichloropropyl) phosphate, tricresyl phosphate, tris(2,3-dibromopropyl) phosphate, tetrakis(2-chloroethyl) ethylenediphosphate, dimethyl methanephosphonate, diethyl diethanolaminomethylphosphonate, and also commercially available halogen-containing flame-retardant polyols. Other phosphates or phosphonates that can be used as liquid flame retardants are diethyl ethanephosphonate (DEEP), triethyl phosphate (TEP), dimethyl propylphosphonate (DMPP), and diphenyl cresyl phosphate (DPC). Flame retardants that can also be used to provide flame retardancy to rigid polyurethane foams, other than the flame retardants mentioned above, are inorganic or organic flame retardants such as red phosphorus, red phosphorus preparations, aluminum oxide hydrate, antimony trioxide, arsenic oxide, ammonium polyphosphate, and calcium sulfate, expandable graphite, or cyanuric acid derivatives, e.g. melamine, or a mixture of at least two flame retardants, e.g. of ammonium polyphosphates and melamine, and also optionally maize starch or ammonium polyphosphate, melamine, and expandable graphite; aromatic polyesters can optionally be used for this purpose.

Flame retardants preferred for the purposes of the present invention comprise no bromine. Particularly preferred flame retardants are composed of atoms selected from the group consisting of carbon, hydrogen, phosphorus, nitrogen, oxygen, and chlorine, more specifically from the group consisting of carbon, hydrogen, phosphorus, and chlorine. Preferred flame retardants have no groups reactive toward isocyanate groups. The flame retardants used in the invention are preferably liquid at room temperature. Particular preference is given to TCPP, DEEP, TEP, DMPP, and DPK, in particular TCPP.

The conventional PUR and PIR catalysts can moreover be added to the composition (Z1). Examples of catalysts that can be used to form urethane structures or isocyanurate structures are carboxylate salts, and also basic, preferably aminic catalysts.

It is advantageous to use basic urethane catalysts, for example tertiary amines such as triethylamine, tributylamine, dimethylbenzylamine, dicyclohexylmethylamine, dimethylcyclohexylamine, and alkanolamine compounds such as triethanolamine, triisopropanolamine, N,N′,N″-tris(dialkylaminoalkyl)hexahydrotriazines, e.g. N,N′,N″-tris(dimethylaminopropyl)-s-hexahydrotriazine, and triethylenediamine. Preference is given to triethylamine, dimethylcyclohexylamine, and N,N′,N″-tris(dialkylaminoalkyl)hexahydrotriazines, e.g. N,N′,N″-tris(dimethylaminopropyl)-s-hexahydrotriazine, particularly preferably dimethylcyclohexylamine.

Possible catalysts that may be mentioned having a carboxylate structure are primarily ammonium or alkali metal carboxylates, preferably alkali metal carboxylate salts, particularly preferably alkali metal formate, alkali metal acetate, or alkali metal hexanoate. Further information relating to the starting materials mentioned and relating to other starting materials can be found in the technical literature, for example in Kunststoffhandbuch, Band VII, Polyurethane [Plastics handbook, volume VII, Polyurethanes], Carl Hanser Verlag Munich, Vienna, 1^{st}, 2^{nd}, and 3^{rd} edition 1966, 1983, and 1993.

It is further optionally possible that other auxiliaries and/or additional substances are added to the composition (Z1). Mention may be made by way of example of surfactant substances, fillers, dyes, pigments, hydrolysis stabilizers, and fungistatic and bacteriostatic substances.

Examples of surfactant substances that can be used are compounds which serve to promote homogenization of the starting materials. Examples that may be mentioned are emulsifiers, for example the sodium salts of castor oil sulfates or of fatty acids, and also salts of fatty acids with amines, e.g. diethylamine oleate, diethanolamine stearate, diethanolamine ricinoleate, salts of sulfonic acids, e.g. alkali metal or ammonium salts of dodecylbenzene- or dinaphthylmethane-disulfonic acid and ricinoleic acid; foam stabilizers, for example siloxane-oxyalkylene copolymers and other organopolysiloxanes, ethoxylated alkylphenols, ethoxylated fatty alcohols, paraffin oils, castor oil esters/ricinoleic esters, Turkey red oil, and peanut oil, and cell regulators, for example paraffins, fatty alcohols, and dimethylpolysiloxanes. Oligomeric acrylates having polyoxyalkylene and fluoroalkane moieties as pendant groups are moreover suitable for improving emulsifying action.

The composition (Z1) can in particular also comprise further additives which improve compatibility between the uncoated surface of the outer layer and the composition (Z1). By way of example, an additive that is sufficiently hydrophobic to hydrophobize the entire composition (Z1) can be added to a hydrophilic composition (Z1). In order to avoid phase separation here for the purposes of the present invention, suitable additives must be miscible with the composition (Z1). Suitable compounds are known to the person skilled in the art. Examples of hydrophobic compounds suitable as additive to a hydrophilic composition (Z1) are oleic acids.

Another embodiment of the present invention accordingly provides a process for the production of a composite element as described above where the composition (Z1) comprises at least one additive which improves compatibility between the uncoated surface of the outer layer and the composition (Z1).

It is also possible to add unreactive solids, known as fillers, in any form to the composition (Z1).

Fillers, in particular reinforcing fillers, are the conventional organic and inorganic fillers known per se, reinforcing agents, weighting agents, agents to improve abrasion behavior in paints, coating compositions, etc. Individual examples that may be mentioned are: inorganic fillers such as silicatic minerals, for example phyllosilicates such as antigorite, serpentine, hornblendes, amphiboles, chrysotile, and talc powder, metal oxides, for example kaolin, aluminum oxides, titanium oxides, and iron oxides, metal salts, for example chalk, baryte, and inorganic pigments, for example cadmium sulfide and zinc sulfide, and also glass, etc. It is preferable to use kaolin (china clay), aluminum silicate, and coprecipitates of barium sulfate and aluminum silicate, and also natural and synthetic fibrous minerals such as wollastonite, and fibers of varying length made of metal and in particular of glass, where these can optionally have been sized. Examples of organic fillers that can be used are: carbon, melamine, rosin, cyclopentadienyl resins, and graft polymers, and also cellulose fibers, and fibers made of polyamide, of polyacrylonitrile, of polyurethane, or of polyester, where these are based on aromatic and/or aliphatic compounds. Particular preference is given here to fillers which have a favorable effect on fire performance, for example expandable graphite, gypsum, chalk, carboxylic esters, and in particular carbon fibers.

The quantity of the composition (Z1) applied in step ii) in the invention is by way of example from 1 to 1000 g/m², preferably from 5 to 800 g/m², more preferably from 10 to 800 g/m², preferably from 10 to 400 g/m², particularly preferably from 50 to 400 g/m², and in particular from 80 to 250 g/m², or from 20 to 250 g/m², and in particular from 25 to 150 g/m².

Another embodiment of the present invention provides a process for the production of a composite element as described above where the quantity applied to the outer layer of the composition (Z1) in step ii) is in the range from 1 to 1000 g/m².

It is preferable in the invention that compatibility between the uncoated surface of outer layer and the composition (Z1) should be sufficient for the quantity applied of the composition (Z1) to form a film that is stable at least for some time on the surface of the outer layer. For the purposes of the present invention it is preferable that the film formed by the composition (Z1) on the surface is stable until the composition (Z2) covers the layer formed by the composition (Z1).

Step iii) of the process of the invention applies, to the layer applied in step ii), a composition (Z2) which is suitable for the production of a polyurethane foam and/or polyisocyanurate foam.

Compositions suitable for the production of a polyurethane foam and/or polyisocyanurate foam are in principle known. Suitable components are known to the person skilled in the art. Suitable components of the composition are in particular polyisocyanates and compounds reactive toward isocyanates. Another embodiment of the present invention accordingly provides a process for the production of a composite element as described above where the composition (Z2) comprises at least one polyisocyanate and at least one compound reactive toward isocyanates.

The composition (Z2) can comprise further components alongside the at least one polyisocyanate of the at least one compound reactive toward isocyanates.

The composition (Z2) in the invention in particular comprises components a) to c), and optionally d) and f):
a) at least one polyisocyanate,
b) at least one compound reactive toward isocyanates,
c) one or more blowing agents,
d) optionally flame retardants,
e) optionally substances catalyzing the PU and/or PIR reaction, and also
f) optionally other auxiliaries or additional substances.

Another embodiment of the present invention accordingly provides a process for the production of a composite element as described above where the composition (Z2) comprises the following components:
a) at least one polyisocyanate,
b) at least one compound reactive toward isocyanates,
c) at least one blowing agent.

Another embodiment of the present invention provides a process for the production of a composite element as described above where the composition (Z2) comprises one or more of the following components:
d) flame retardants,
e) catalysts for polyurethane formation or polyisocyanurate formation,
f) further auxiliaries or additional substances.

The composition (Z2) comprises, as component b) in the invention, at least one compound reactive toward isocyanates. Suitable compounds reactive toward isocyanates are in principle the compounds mentioned above in connection with the composition (Z1).

Component b) here preferably comprises polyethers and/or polyesters.

Component b) is preferably composed of more than 10% by weight, particularly preferably of more than 30% by weight, in particular of more than 50% by weight, more specifically of more than 70% by weight, still more specifically of more than 80% by weight, more preferably of more than 90% by weight, and most preferably of 100% by weight, based on the quantity of component b), of polyesters.

The composition (Z2) in the invention comprises at least one polyisocyansate as component a). For the purposes of the present invention the term polyisocyanate means an organic compound which comprises at least two reactive isocyanate groups per molecule; i.e. functionality is at least 2. Insofar as the polyisocyanates used, or a mixture of a plurality of polyisocyanates, do not have uniform functionality, the number-average functionality value of component a) used is at least 2.

Polyisocyanates a) that can be used are the aliphatic, cycloaliphatic, araliphatic and preferably aromatic polyfunctional isocyanates. These polyfunctional isocyanates are known per se or can be produced by methods known per se. The polyfunctional isocyanates can also in particular be used in the form of mixtures, and in this case component a) therefore comprises a variety of polyfunctional isocyanates. Polyfunctional isocyanates that can be used as isocyanate have two or more isocyanate groups per molecule (the term diisocyanates being used for the former).

Specific mention may in particular be made of: alkylene diisocyanates having from 4 to 12 carbon atoms in the alkylene moiety, for example dodecane 1,12-diisocyanate, 2-ethyltetramethylene 1,4-diisocyanate, 2-methylpentamethylene 1,5-diisocyanate, tetramethylene 1,4-diisocyanate, and preferably hexamethylene 1,6-diisocyanate; cycloaliphatic diisocyanates such as cyclohexane 1,3- and 1,4-diisocyanate, and also any desired mixtures of these isomers, 1-isocyanato-3,3,5-trimethyl-5-isocyanatomethylcyclohexane (IPDI), hexahydrotolylene 2,4- and 2,6-diisocyanate, and also the corresponding isomer mixtures, dicyclohexylmethane 4,4′-, 2,2′- and 2,4′-diisocyanate, and also the corresponding isomer mixtures, and preferably aromatic polyisocyanates, for example tolylene 2,4- and 2,6-diisocyanate and the corresponding isomer mixtures, diphenylmethane 4,4′-, 2,4′- and 2,2′-diisocyanate and the corresponding isomer mixtures, mixtures of diphenylmethane 4,4′- and 2,2′-diisocyanates, polyphenyl polymethylene polyisocyanates, mixtures of diphenylmethane 4,4′-, 2,4′- and 2,2′-diisocyanates and polyphenyl polymethylene polyisocyanates (crude MDI) and mixtures of crude MDI and tolylene diisocyanates. Particularly suitable materials are diphenylmethane 2,2′-, 2,4′- and/or 4,4′-diisocyanate (MDI), naphthylene 1,5-diisocyanate (NDI), tolylene 2,4- and/or 2,6-diisocyanate (TDI), dimethyldiphenyl 3,3′-diisocyanate, 1,2-diphenylethane diisocyanate and/or p-phenylene diisocyanate (PPDI), tri-, tetra-, penta-, hexa-, hepta- and/or octamethylene diisocyanate, 2-methylpentamethylene 1,5-diisocyanate, 2-ethylbutylene 1,4-diisocyanate, pentamethylene 1,5-diisocyanate, butylenes 1,4-diisocyanate, 1-isocyanato-3,3,5-trimethyl-5-iso-cyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate and dicyclohexylmethane 4,4′-, 2,4′- and/or 2,2′-diisocyanate. Modified polyisocyanates are often also used, these being products obtained via chemical reaction of organic polyisocyanates and having at least two reactive isocyanate groups per molecule. In particular, mention may be made of polyisocyanates comprising ester, urea, biuret, allophanate, carbodiimide, isocyanurate, uretdione, carbamate and/or urethane groups.

The following embodiments are particularly preferred as polyisocyanates of component a): i) polyfunctional isocyanates based on tolylene diisocyanate (TDI), in particular 2,4-TDI or 2,6-TDI or a mixture of 2,4- and 2,6-TDI; ii) polyfunctional isocyanates based on diphenylmethane diisocyanate (MDI), in particular 2,2′-MDI or 2,4′-MDI or 4,4′-MDI or oligomeric MDI, which is also termed polyphenyl polymethylene isocyanate, or a mixture of two or three of the abovementioned diphenylmethane diisocyanates, or crude MDI, which arises during the production of MDI, or a mixture of at least one oligomer of MDI and at least one of the abovementioned low-molecular-weight MDI derivatives; iii) mixtures of at least one aromatic isocyanate of embodiment i) and at least one aromatic isocyanate of embodiment ii). Very particular preference is given to polymeric diphenylmethane diisocyanate as polyisocyanate. Polymeric diphenylmethane diisocyanate (hereinafter termed polymeric MDI) is a mixture of MDI comprising two rings and oligomeric condensates and therefore derivatives of diphenylmethane diisocyanate (MDI). The polyisocyanates can preferably also be composed of mixtures of monomeric aromatic diisocyanates and polymeric MDI.

Polymeric MDI comprises not only MDI comprising two rings but also one or more condensates of MDI having a plurality of rings and functionality of more than 2, in particular 3 or 4 or 5. Polymeric MDI is known and is often termed polyphenyl polymethylene isocyanate or oligomeric MDI. Polymeric MDI is usually composed of a mixture of MDI-based isocyanates with different functionality. Polymeric MDI is usually used in a mixture with monomeric MDI.

The (average) functionality of a polyisocyanate comprising polymeric MDI can vary in the range from about 2.2 to about 5, in particular from 2.3 to 4, in particular from 2.4 to 3.5. In particular crude MDI obtained as intermediate during the production of MDI, is a mixture of this type of MDI-based polyfunctional isocyanates with different functionalities.

Polyfunctional isocyanates and mixtures of a plurality of polyfunctional isocyanates based on MDI are known and are marketed by way of example as Lupranat® by BASF Polyurethanes GmbH.

The functionality of component a) is preferably at least 2, in particular at least 2.2 and particularly preferably at least 2.4. The functionality of component a) is preferably from 2.2 to 4 and particularly preferably from 2.4 to 3. The content of isocyanate groups of component a) is preferably from 5 to 10 mmol/g, in particular from 6 to 9 mmol/g, particularly preferably from 7 to 8.5 mmol/g. The person skilled in the art is aware that there is a reciprocal relationship between the content of isocyanate groups in mmol/g and what is known as the equivalent weight in g/equivalent. The content of isocyanate groups in mmol/g is obtained from the content in % by weight in accordance with ASTM D5155-96 A.

In a particularly preferred embodiment component a) is composed of at least one polyfunctional isocyanate selected from diphenylmethane 4,4′-diisocyanate, diphenylmethane 2,4′-diisocyanate, diphenylmethane 2,2′-diisocyanate and oligomeric diphenylmethane diisocyanate. For the purposes of this preferred embodiment component a) particularly preferably comprises oligomeric diphenylmethane diisocyanate and has a functionality of at least 2.4.

The viscosity of component a) can vary widely. The viscosity of component a) is preferably from 100 to 3000 mPa*s, particularly preferably from 100 to 1000 mPa*s, with particular preference from 100 to 600 mPa*s, more specifically from 200 to 600 mPa*s and very specifically from 400 to 600 mPa*s at 25° C.

Other suitable components c) to f) which can be comprised in the composition (Z2) are known in principle to the person skilled in the art. Components c) to f) that are preferred in the invention are in particular mentioned in the context of the composition (Z1).

The composition (Z2) in the invention preferably comprises components a), b) and c), and optionally d), e) and f). The quantities of the polyisocyanates a) mixed in the invention here with the compounds b) reactive toward isocyanates, the blowing agents c) and the optional other components d) to f) are preferably such that the equivalence ratio of NCO groups of the polyisocyanates a) to the entirety of the hydrogen atoms that are reactive toward isocyanates and are present in components b) to f) is greater than 1:1, preferably greater than 1.2:1, particularly preferably greater than 1.5:1, more specifically greater than 1.8:1, still more specifically greater than 2:1, more specifically greater than 2.5:1 and in particular greater than 3:1.

It is further preferable that the equivalence ratio of NCO groups of the polyisocyanates a) to the entirety of the hydrogen atoms that are reactive toward isocyanates and are present in components b) to f) is smaller than 10:1, preferably smaller than 8:1, more specifically smaller than 6:1, still more specifically smaller than 5:1, more specifically smaller than 4.5:1, very specifically smaller than 4:1 and in particular smaller than 3.5:1.

Application of the composition (Z2) in step iii) can also take place in a continuous production system. The thickness of this layer can by way of example be from 0.5 cm to 30 cm, preferably from 2 cm to 22 cm and particularly preferably from 12 cm to 20 cm.

In another embodiment the present invention provides a process for the production of a composite element as described above where the thickness of the layer applied in step iii) is in the range from 0.5 to 30 cm.

Processes for the application of a composition suitable for the production of a polyurethane foam and/or polyisocyanurate foam are known in principle to the person skilled in the art.

In an advantageous manner, mixing of the reaction components for formation of the foam, in a mixing head, is delayed until immediately prior to application, and the composition (Z2) is then immediately applied to the layer formed from the composition (Z1), so that formation of the foam takes place on the outer layer provided with the composition (Z1). It is particularly preferable here to use what is known as the twin-belt process for the production of the composite elements. In particular, it is advantageous here to use rigid polyurethane foams comprising polyisocyanurate or comprising polyisocyanurate structures, because these have good flame-retardant properties even with relatively low content of flame retardant.

A further layer, in particular an outer layer, can be applied to the layer applied in step iii). Adhesion to the upper outer layer used in the process, being optionally applied in step iv), is usually adequate even without use of an adhesion promoter, and it is therefore preferable for the purposes of the present invention to use no adhesion promoter between the layer applied in step iii) and the outer layer applied in step iv).

Another embodiment of the present invention accordingly provides a process for the production of a composite element as described above where the process comprises a step iv):
iv) application of an outer layer to the layer applied in step iii).

It is possible in the invention that the further outer layer is applied before complete hardening of the layer applied in step iii). However, it is also possible in the invention that the further outer layer is applied after complete hardening of the layer applied in step iii), for example with use of a tie layer.

The further outer layer can be identical with or different from the first outer layer. The further outer layer in the invention can be a coated or uncoated layer, preferably a coated layer. By way of example, it is a metal foil, and thickness here is also in the usual ranges, for example from 0.01 mm to 5 mm, preferably from 0.05 mm to 2 mm, particularly preferably from 0.1 mm to 1 mm, more specifically from 0.2 mm to 0.8 mm and specifically from 0.3 mm to 0.7 mm.

It is preferable in the invention to use a coated outer layer, more preferably an outer layer with one uncoated surface and one coated surface coated as described above at least to some extent with a composition (B) comprising at least one inorganic material. The manner of application of the outer layer here is such that the uncoated side of the outer layer is applied in contact with the layer applied in step iii).

It is preferable in the invention that the uncoated side of the outer layer to be applied is treated as described above, i.e. that by way of example a treatment selected from corona treatment, plasma treatment, flame treatment and application of a composition (Z1) comprising at least one adhesion promoter is carried out before the outer layer is brought into contact with the layer applied in step iii).

Another embodiment of the present invention provides a process for the production of a composite element as described above where the second outer layer is a metal foil and where the thickness of the outer layer is preferably in the range from 0.01 mm to 5.0 mm.

Another aspect of the present invention also provides composite elements obtainable or obtained by a process for the production of a composite element as described above. The composite elements of the invention are in particular suitable for the construction of façades.

Another aspect of the present invention also provides the use of a composite element obtainable or obtained by a process for the production of a composite element as described above, or of a composite element as described above, as insulation material or in construction of façades.

Other embodiments of the present invention can be found in the claims and the examples. The features mentioned above of the inventive product/process/uses, and those explained below, can of course be used not only in the respective stated combination but also in other combinations without exceeding the scope of the invention. The invention also implicitly therefore comprises by way of example the combination of a preferred feature with a particularly preferred feature, or of a particularly preferred feature with a feature that has no further characterization, etc., even when there is no express mention of this combination.

Examples of embodiments of the present invention are listed below, but these do not restrict the present invention. In particular, the present invention also comprises embodiments resulting from the dependences stated below, i.e. from combinations.

1. A process for the production of a composite element, at least comprising the following steps:
i) provision of an outer layer with an uncoated surface and a coated surface coated at least partially with a composition (B) comprising at least one inorganic material;
ii) treatment of the uncoated surface of the outer layer;
iii) application, to the outer-layer surface treated in step ii), of a composition (Z2) suitable for the production of a polyurethane foam and/or polyisocyanurate foam.

2. The process according to embodiment 1, where the composition (B) has coated at least 50% of the coated surface of the outer layer.

3. The process according to embodiment 1 or 2, where the treatment in step ii) is selected from corona treatment, plasma treatment, flame treatment, and application of a composition (Z1) comprising at least one adhesion promoter.

4. The process according to any of embodiments 1 to 3, where the treatment in step ii) comprises application of a composition (Z1) comprising at least one adhesion promoter.

5. The process according to any of embodiments 1 to 4, where the composition (B) comprises from 70 to 95% by weight of a pulverulent inorganic material and from 5 to 30% by weight of a binder, based in each case on the entire composition (B).

6. The process according to any of embodiments 1 to 5, where the composition (B) has coated at least 75% of the coated surface of the outer layer.

7. The process according to any of embodiments 1 to 6, where the outer layer is impermeable to diffusion.

8. The process according to any of embodiments 1 to 7, where the outer layer has a plurality of sublayers.

9. The process according to any of embodiments 1 to 8, where the outer layer comprises a plastics foil that is impermeable to diffusion or a metal foil.

10. The process according to any of embodiments 1 to 9, where the thickness of the at least partially coated outer layer is from 0.01 mm to 5.0 mm.

11. The process according to any of embodiments 3 to 10, where the adhesion promoter is a compound reactive toward isocyanates or is a polyisocyanate prepolymer.

12. The process according to embodiment 11, where the at least one compound reactive toward isocyanates is selected from the group consisting of compounds having OH functional groups, compounds having NH functional groups, and compounds having SH functional groups.

13. The process according to embodiment 11 or 12, where the at least one compound reactive toward isocyanates is selected from the group consisting of polyethers, polyesters, compounds bearing ester and ether groups, compounds bearing urethane, ester and/or ether groups and compounds bearing urethane groups.

14. The process according to any of embodiments 3 to 10, where the composition (Z1) comprises at least one compound reactive toward isocyanates and comprises at least one polyisocyanate.

15. The process according to any of embodiments 1 to 14, where the composition (Z2) comprises at least one polyisocyanate and comprises at least one compound reactive toward isocyanate.

16. The process according to any of embodiments 1 to 15, where the composition (Z2) comprises the following components:
a) at least one polyisocyanate;
b) at least one compound reactive toward isocyanates;
c) at least one blowing agent.

17. The process according to any of embodiments 3 to 16, where the composition (Z1) comprises at least one additive which improves compatibility between the uncoated surface of the outer layer and the composition (Z1).

18. The process according to any of embodiments 3 to 17, where the composition (Z1) is applied to the outer layer by means of spray-application or rolling.

19. The process according to any of embodiments 1 to 18, where the process comprises a step iv):
iv) application of an outer layer to the layer applied in step iii).

20. A composite element obtainable or obtained by a process according to any of embodiments 1 to 19.

21. The use of a composite element obtainable or obtained by a process according to any of embodiments 1 to 19 or of a composite element according to embodiment 20 as insulation material or in construction of façades.

22. A process for the production of a composite element, at least comprising the following steps:
i) provision of an outer layer with an uncoated surface and a coated surface coated at least partially with a composition (B) comprising at least one inorganic material;
ii) treatment of the uncoated surface of the outer layer;
iii) application, to the outer-layer surface treated in step ii), of a composition (Z2) suitable for the production of a polyurethane foam and/or polyisocyanurate foam,
where the composition (B) has coated at least 50% of the coated surface of the outer layer, where the composition (B) comprises from 70 to 95% by weight of a pulverulent inorganic material and from 5 to 30% by weight of a binder, based in each case on the entire composition (B).

23. Process according to embodiment 22, where the treatment in step ii) is selected from corona treatment, plasma treatment, flame treatment and application of a composition (Z1) comprising at least one adhesion promoter.

24. The process according to embodiment 22 or 23, where the treatment in step ii) comprises application of a composition (Z1) comprising at least one adhesion promoter.

25. The process according to any of embodiments 22 to 24, where the composition (B) has coated at least 75% of the coated surface of the outer layer.

26. The process according to any of embodiments 22 to 25, where the outer layer is impermeable to diffusion.

27. The process according to any of claims 22 to 26, where the outer layer has a plurality of sublayers.

28. The process according to any of claims 22 to 27, where the outer layer comprises a plastics foil that is impermeable to diffusion or a metal foil.

29. The process according to any of claims 22 to 28, where the thickness of the at least partially coated outer layer is from 0.01 mm to 5.0 mm.

30. The process according to any of claims 23 to 29, where the adhesion promoter is a compound reactive toward isocyanates or is a polyisocyanate prepolymer.

31. The process according to claim 30, where the at least one compound reactive toward isocyanates is selected from the group consisting of compounds having OH functional groups, compounds having NH functional groups, and compounds having SH functional groups.

32. The process according to claim 30 or 31, where the at least one compound reactive toward isocyanates is selected from the group consisting of polyethers, polyesters, compounds bearing ester and ether groups, compounds bearing urethane, ester and/or ether groups and compounds bearing urethane groups.

33. The process according to any of claims 23 to 29, where the composition (Z1) comprises at least one compound reactive toward isocyanates and comprises at least one polyisocyanate.

34. The process according to any of claims 22 to 33, where the composition (Z2) comprises at least one polyisocyanate and comprises at least one compound reactive toward isocyanates.

35. The process according to any of claims 22 to 34, where the composition (Z2) comprises the following components:
a) at least one polyisocyanate;
b) at least one compound reactive toward isocyanates;
c) at least one blowing agent.

36. The process according to any of claims 23 to 35, where the composition (Z1) comprises at least one additive which improves compatibility between the uncoated surface of the outer layer and the composition (Z1).

37. The process according to any of claims 23 to 36, where the composition (Z1) is applied to the outer layer by means of spray-application or rolling.

38. The process according to any of claims 1 to 37, where the process comprises a step iv):
iv) application of an outer layer to the layer applied in step iii).

39. A composite element obtainable or obtained by a process according to any of claims 22 to 38.

40. The use of a composite element obtainable or obtained by a process according to any of claims 22 to 38 or of a composite element according to claim 39 as insulation material or in construction of façades.

41. A process for the production of a composite element, at least comprising the following steps:
i) provision of an outer layer with an uncoated surface and a coated surface coated at least partially with a composition (B) comprising at least one inorganic material;
ii) treatment of the uncoated surface of the outer layer;
iii) application, to the outer-layer surface treated in step ii), of a composition (Z2) suitable for the production of a polyurethane foam and/or polyisocyanurate foam, and
iv) application of an outer layer to the layer applied in step iii),
where the composition (B) has coated at least 50% of the coated surface of the outer layer, where the composition (B) comprises from 70 to 95% by weight of a pulverulent inorganic material and from 5 to 30% by weight of a binder, based in each case on the entire composition (B).

The examples below are intended for further explanation of the invention.

### EXAMPLES

### I. Production Example

An overhead mixer was used to foam polymeric MDI with isocyanate-reactive components, blowing agents, catalysts and all the other additional substances in a beaker, and the product was charged to a box mold (20×20×8 cm³) controlled to a temperature of 60° C. and equipped with outer layer (vliepatex WDVS DD, thickness about 0.5 mm, barrier foil facing toward the reaction mixture) above and below; after input of the reaction mixture, the mold was closed in order to obtain a foam with outer layer applied above and below.

The following polyol component was used in all of the experiments:

61 parts by weight of polyesterol composed of the esterification product of terephthalic acid, glycerol, diethylene glycol and oleic acid.

8 parts by weight of polyetherol made of ethoxylated ethylene glycol with hydroxy functionality 2 and hydroxy number 190 mg/KOH/g.

27.5 parts by weight of trichloroisopropyl phosphate (TCPP) flame retardant.

2.5 parts by weight of Tegostab® B8498 (silicone-containing stabilizer from Evonik).

2.7 parts by weight of water.

0.8 part by weight of dipropylene glycol.

Additional substances:

15 parts by weight of 70:30 cyclopentane/pentane.

2 parts by weight of potassium acetate solution (47% by weight of ethylene glycol).

also bis(2-dimethylaminoethyl) ether solution (33% by weight in dipropylene glycol) to adjust fiber times.

Isocyanate component:

A quantity of Lupranat® M50 (polymeric methylenediphenyl diisocyanate (PMDI) with viscosity about 500 mPa*s at 25° C. from BASF SE) sufficient to achieve an index of 280. Isocyanate component and polyol component were used in a ratio by weight of 206:100.

The quantity of reaction mixture in the box mold was selected to give a foam of envelope density 33 +/−2 g/l. Fiber time was moreover adjusted to 47 +/−2 s by varying the proportion of the bis(2-dimethylaminoethyl) ether solution (33% by weight in dipropylene glycol).

The lower outer layer on which the reaction mixture was applied was directly treated in the following manner directly before placing in the box mold:

### Comparative Example

No pretreatment

### Inventive Example 1

Application of a polyetherol made of propoxylated propylene glycol with hydroxy functionality 2 and hydroxy number 28 mg KOH/g; a manual coater was used here to apply the polyetherol in a layer thickness of 250 μm.

### Inventive Example 2

Application of a polyetherol made of sequentially ethoxylated and propoxylated glycerol with hydroxy functionality 3 and hydroxy number 160 mg KOH/g; a manual coater was used here to apply the polyetherol in a layer thickness of 250 μm.

### Inventive Example 3

Application of a polyetherol made of ethoxylated glycerol with hydroxy functionality 3 and hydroxy number 540 mg KOH/g; a manual coater was used here to apply the polyetherol in a layer thickness of 250 μm.

### Inventive Example 4

Application of a polyetherol made of castor oil with hydroxy functionality 3 and hydroxy number 160 mg KOH/g; a manual coater was used here to apply the polyetherol in a layer thickness of 250 μm.

### Inventive Example 5

Application of a polyetherol made of sequentially ethoxylated and propoxylated glycerol with hydroxy functionality 3 and hydroxy number 160 mg KOH/g comprising 5% by weight of oleic acid; a manual coater was used here to apply the polyetherol in a layer thickness of 250 μm.

### Inventive Example 6

Application of a prepolymer made of propoxylated propylene glycol with hydroxy functionality 2 and hydroxy number 28 mg KOH/g and Lupranat® M20 (polymeric methylenediphenyl diisocyanate (PMDI) with viscosity about 200 mPa*s at 25° C. from BASF SE), NCO content of the prepolymer being 15%; a manual coater was used here to apply the prepolymer in a layer thickness of 250 μm.

### Inventive Example 7

Application of a prepolymer made of sequentially ethoxylated and propoxylated propylene glycol with hydroxy functionality 2 and hydroxy number 30 mg KOH/g and Lupranat® M20 (polymeric methylenediphenyl diisocyanate (PMDI) with viscosity about 200 mPa*s at 25° C. from BASF SE), NCO content of the prepolymer being 15%; a manual coater was used here to apply the prepolymer in a layer thickness of 250 μm.

### Inventive Example 8

Application of a prepolymer made of sequentially ethoxylated and propoxylated propylene glycol with hydroxy functionality 2 and hydroxy number 30 mg KOH/g and Lupranat® M20 (polymeric methylenediphenyl diisocyanate (PMDI) with viscosity about 200 mPa*s at 25° C. from BASF SE), NCO content of the prepolymer being 10%; a manual coater was used here to apply the prepolymer in a layer thickness of 250 μm.

### Inventive Example 9

Application of a prepolymer made of sequentially ethoxylated and propoxylated propylene glycol with hydroxy functionality 2 and hydroxy number 30 mg KOH/g and Lupranat® M20 (polymeric methylenediphenyl diisocyanate (PMDI) with viscosity about 200 mPa*s at 25° C. from BASF SE), NCO content of the prepolymer being 20%; a manual coater was used here to apply the prepolymer in a layer thickness of 250 μm.

After production of the samples, they were stored for 24 hours at room temperature (from 18 to 22° C.). The following were then determined: peel strength in accordance with the general test specification A as described below, based on VW PV 2034, and tensile strength in accordance with DIN 53292/DIN EN ISO 527-1. In each case three specimens were tested and the average was calculated. The stability of the film produced prior to foaming on the lower outer layer was moreover evaluated qualitatively.

Good film quality was indicated by stability for at least 30 s, where this means that no holes developed in the film that would have led to inhomogeneous covering of the outer layer and could have had an adverse effect on adhesion of the foam on the outer layer. Table 1 collates the results.

TABLE 1

| | Tensile bond strength | Peel strength | Film |
|---|---|---|---|
| | [N/mm²] | [N/5 cm] | quality |
| Comparative example | 0.04 +/− 0.02 | 3.5 +/− 1.6 | no film |
| Inventive example 1 | 0.11 +/− 0.02 | 12 +/− 2 | good |
| Inventive example 2 | 0.07 +/− 0.02 | 13 +/− 4 | poor |
| Inventive example 3 | 0.05 +/− 0.03 | 6.1 +/− 0.9 | very poor |
| Inventive example 4 | 0.13 +/− 0.04 | 9.4 +/− 1.6 | good |
| Inventive example 5 | 0.13 +/− 0.01 | 10.1 +/− 1.3 | moderate |
| Inventive example 6 | 0.16 +/− 0.02 | 22 +/− 2 | good |
| Inventive example 7 | 0.15 +/− 0.02 | 28 +/− 5 | good |
| Inventive example 8 | 0.12 +/− 0.02 | 27 +/− 12 | good |
| Inventive example 9 | 0.12 +/− 0.02 | 18.4 +/− 1.8 | good |

### II. Production Example/Testing of Composites

Rigid PIR foam sheets were produced from a commercially obtainable PIR formulation (Elastopir®) in a twin-belt system by a continuous process conventionally used in the industry. The thickness of the rigid PIR foam sheets was 100 mm, with density from 30 to 31 g/l. The following outer layer variants were used:
Vliepatex WDVS DD outer layer on upper side and lower side (foil composite impermeable to diffusion with single-side inorganic coating, thickness about 0.5 mm, barrier layer facing toward the insulation material)
Vliepatex WDVS DD outer layer on upper side and lower side; application of a two-component adhesion promoter to the lower outer layer prior to application of the PIR reaction mixture (spinning disk)
commercially available aluminum outer layer (50 μm, also termed “alu” below) on upper side and lower side
commercially available aluminum outer layer (50 μm) on upper side and lower side; application of a two-component adhesion promoter to the lower outer layer prior to application of the PIR reaction mixture (spinning disk)

The sheets were then subjected to a tensile bond strength test based upon the Guideline for European Technical Approvals for external composite thermal insulation systems with rendering (ETAG 004, section 5.1.4.1): The lower side of the insulation sheets was coated with mortar (Heck K+A, dry ready-mix mortar in accordance with DIN 18350) and then stored for seven days at 23° C. and 50% rel. humidity and 21 days at 23° C. in water. An angle grinder was used to make cuts through the mortar and the outer layer, extending just into the insulation material, thus giving six squares measuring 50×50 mm. An adhesive was used to fix square metal sheets measuring 50×50 mm on the cut-out areas. The tensile bond strength of the insulation-material-outer-layer-mortar composite was then measured (F 20 DEASY M 2000, class 1 tester with official calibration, test velocity 125 N/s with no preloading). For composite thermal insulation systems the Guideline requires an average minimal tensile bond strength of 0.08 N/mm² or fracture within the insulation material.

TABLE 2

| | | | | Measured | Adequate in |
|---|---|---|---|---|---|
| | Outer | Adhesion | | value | accordance |
| Sample | layer | promoter (AP) | Failure | [N/mm²] | with ETAG 004 |
| 1.1 | Vliepatex | no AP | interface | 0.070 | |
| | WDVS DD | | | | |
| 1.2 | Vliepatex | no AP | interface | 0.060 | |
| | WDVS DD | | | | |
| 1.3 | Vliepatex | no AP | interface | 0.040 | |
| | WDVS DD | | | | |
| 1.4 | Vliepatex | no AP | interface | 0.041 | |
| | WDVS DD | | | | |
| 1.5 | Vliepatex | no AP | interface | 0.046 | |
| | WDVS DD | | | | |
| 1.6 | Vliepatex | no AP | interface | 0.042 | |
| | WDVS DD | | | | |
| 1 | Vliepatex | no AP | | 0.050 ± 0.012 | No |
| (Average) | WDVS DD | | | | |
| 2.1 | Vliepatex | with AP | interface | 0.096 | |
| | WDVS DD | | | | |
| 2.2 | Vliepatex | with AP | interface | 0.084 | |
| | WDVS DD | | | | |
| 2.3 | Vliepatex | with AP | coating | 0.110 | |
| | WDVS DD | | | | |
| 2.4 | Vliepatex | with AP | coating | 0.082 | |
| | WDVS DD | | | | |
| 2.5 | Vliepatex | with AP | interface | 0.092 | |
| | WDVS DD | | | | |
| 2.6 | Vliepatex | with AP | insulation | 0.074 | |
| | WDVS DD | | material | | |
| 2 | Vliepatex | with AP | | 0.090 ± 0.013 | yes |
| (Average) | WDVS DD | | | | |
| 3.1 | Alu | no AP | interface | 0.005 | |
| 3.2 | Alu | no AP | interface | — | |
| 3.3 | Alu | no AP | interface | 0.006 | |
| 3.4 | Alu | no AP | interface | 0.003 | |
| 3.5 | Alu | no AP | interface | 0.003 | |
| 3.6 | Alu | no AP | interface | 0.005 | |
| 3 | Alu | no AP | | 0.004 ± 0.001 | no |
| (Average) | | | | | |
| 4.1 | Alu | with AP | interface | 0.004 | |
| 4.2 | Alu | with AP | interface | 0.005 | |
| 4.3 | Alu | with AP | interface | 0.005 | |
| 4.4 | Alu | with AP | interface | 0.002 | |
| 4.5 | Alu | with AP | interface | 0.005 | |
| 4.6 | Alu | with AP | interface | 0.006 | |
| 4 | Alu | with AP | | 0.005 ± 0.001 | no |
| (Average) | | | | | |

The minimal value required by the composite thermal insulation systems standard: 0.08 N/mm² or fracture within the insulation material is achieved only with adhesion promoter and Vliepatex WDVS DD outer layer.

### III. Test Specification A for Determination of Peel Strength: Roller Peel Test Based on VW PV 2034

A longitudinal section of about 50 mm of the adhering outer layer of a sample measuring 170×50 mm cut from a composite element was released from the substrate material. The sample is inserted into a floating-roller unit (two rollers, diameter 20 mm, length about 57 mm, separation 6 mm) clamped into the upper clamping jaw of a universal tester (UT). The flexible released end section is passed downward between the rollers at an angle of 90° and fixed in the lower clamp of the UT. Once the pretensioning force has reached 4 N, the flexible material is peeled from the substrate material at an angle of 90° (roller) at a test velocity of 50 mm/min.

The test continues for 100 mm and is then terminated. Six reference forces are determined at intervals of 10 mm at test positions between 25 mm and 75 mm. The peel force is calculated from the average of these six reference forces and is stated in N/5 cm.

1. A process for the production of a composite element, the process comprising:
i) provision of an outer layer with an uncoated surface and a coated surface coated at least partially with a composition (B) comprising at least one inorganic material;
ii) treatment of the uncoated surface of the outer layer; and
iii) application, to the outer-layer surface treated in step ii), of a composition (Z2) suitable for the production of a polyurethane foam and/or polyisocyanurate foam,
wherein the composition (B) has coated at least 50% of the coated surface of the outer layer, and
wherein the composition (B) comprises from 70 to 95% by weight of a pulverulent inorganic material and from 5 to 30% by weight of a binder, based in each case on the entire composition (B), and
wherein the outer layer is impermeable to diffusion.

2. The process according to claim 1, wherein the treatment in step ii) is selected from the group consisting of corona treatment, plasma treatment, flame treatment, and application of a composition (Z1) comprising at least one adhesion promoter.

3. The process according to claim 1, wherein the treatment in step ii) comprises application of a composition (Z1) comprising at least one adhesion promoter.

4. The process according to claim 1, wherein the composition (B) has coated at least 75% of the coated surface of the outer layer.

5. The process according to claim 1, wherein the outer layer has a plurality of sublayers.

6. The process according to claim 1, wherein the outer layer comprises a plastics foil that is impermeable to diffusion or a metal foil.

7. The process according to claim 1, wherein the thickness of the at least partially coated outer layer is from 0.01 mm to 5.0 mm.

8. The process according to claim 2, wherein the adhesion promoter is one of a compound reactive toward isocyanates and a polyisocyanate prepolymer.

9. The process according to claim 8, wherein the compound reactive toward isocyanates is selected from the group consisting of compounds having OH functional groups, compounds having NH functional groups, and compounds having SH functional groups.

10. The process according to claim 8, wherein the compound reactive toward isocyanates is selected from the group consisting of polyethers, polyesters, compounds bearing ester and ether groups, compounds bearing urethane and ester groups, compounds bearing urethane and ether groups, compounds bearing urethane, ester, and ether groups, and compounds bearing urethane groups.

11. The process according to claim 2, wherein the composition (Z1) comprises at least one compound reactive toward isocyanates and comprises at least one polyisocyanate.

12. The process according to claim 1, wherein the composition (Z2) comprises at least one polyisocyanate and comprises at least one compound reactive toward isocyanates.

13. The process according to claim 1, wherein the composition (Z2) comprises:
a) at least one polyisocyanate;
b) at least one compound reactive toward isocyanates; and
c) at least one blowing agent.

14. The process according to claim 2, wherein the composition (Z1) comprises at least one additive which improves compatibility between the uncoated surface of the outer layer and the composition (Z1).

15. The process according to claim 2, wherein the composition (Z1) is applied to the outer layer by means of spray-application or rolling.

16. The process according to claim 1, wherein the process comprises a step iv):
iv) application of an outer layer to the layer applied in step iii).

17. A composite element obtainable by the process according to claim 1.

18. An insulation material comprising the composite element of claim 17.

19. A material for use in construction of façades comprising the composite element of claim 17.
